(19) United States
(12) Patent Application Publication
(10) Pub. No.: US 2026/0051764 A1
(43) Pub. Date: Feb. 19, 2026

(54) BIDIRECTIONAL UNINTERRUPTIBLE POWER SUPPLY

(71) Applicant: Enphase Energy, Inc., Petaluma, CA (US)

(72) Inventors: Chris Morrow YOUNG, Round Rock, TX (US); Christopher Scott COUTURE, Leander, TX (US)

(21) Appl. No.: 19/275,137

(22) Filed: Jul. 21, 2025

Related U.S. Application Data
(60) Provisional application No. 63/682,991, filed on Aug. 14, 2024.

(51) Int. Cl. H02J 9/06

(52) U.S. Cl. CPC H02J 9/062

(57) ABSTRACT

An uninterrupted power supply configured for use with an energy management system comprises a battery configured to connect to a cable that connects to an electrical receptacle of a structure for exporting and importing power to and from an AC bus connected to the energy management system, an electrical receptable located on the uninterrupted power supply and configured to provide AC power to a load connected to the uninterrupted power supply, and a controller configured to switch between a first mode of operation for exporting and importing power to and from the AC bus and a second mode of operation for providing AC power to the load.

### CROSS-REFERENCE TO RELATED APPLICATIONS

The present application claims the benefit of and priority to U.S. Provisional Application Ser. No. 63/682,991, filed on Aug. 14, 2024, the entire contents of which is incorporated herein by reference.

### BACKGROUND

### 1. Field of the Disclosure

Embodiments of the present disclosure generally relate to energy management systems and, for example, to energy management systems comprising uninterruptible power supplies.

### 2. Description of the Related Art

Conventional power conversion systems (energy management systems) are very well known. For example, some energy management systems comprise one or more distributed energy resources (DER), a DER controller, and one or more storage units (a permanent battery) that are configured to provide power to one or more loads (e.g., when an energy management system is off-grid). While such storage units are suitable for their intended purpose, installing the storage units can sometimes be expensive, and obtaining permits for installing the storage units can be time consuming and cumbersome.

Therefore, described herein are improved energy management systems comprising uninterruptible power supplies.

### SUMMARY

In accordance with some aspects of the present disclosure, there is provided an uninterrupted power supply configured for use with an energy management system. The uninterrupted power supply comprises a battery configured to connect to a cable that connects to an electrical receptacle of a structure for exporting and importing power to and from an AC bus connected to the energy management system, an electrical receptable located on the uninterrupted power supply and configured to provide AC power to a load connected to the uninterrupted power supply, and a controller configured to switch between a first mode of operation for exporting and importing power to and from the AC bus and a second mode of operation for providing AC power to the load.

In accordance with some aspects of the present disclosure, there is provided an energy management system, comprising a distributed energy resource controlled by a distributed energy resource controller, a load center and an uninterrupted power supply comprising a battery configured to connect to a cable that connects to an electrical receptacle of a structure for exporting and importing power to and from an AC bus connected to the energy management system, an electrical receptable located on the uninterrupted power supply and configured to provide AC power to a load connected to the uninterrupted power supply, and a controller configured to switch between a first mode of operation for exporting and importing power to and from the AC bus and a second mode of operation for providing AC power to the load.

In accordance with some aspects of the present disclosure, there is provided a method for controlling an energy management system. The method comprises determining, at an uninterrupted power supply, a mode of operation of the energy management system. The uninterrupted power supply comprises a battery configured to connect to a cable that connects to an electrical receptacle of a structure for exporting and importing power to and from an AC bus connected to the energy management system and an electrical receptable located on the uninterrupted power supply and configured to provide AC power to a load connected to the uninterrupted power supply. Based on a determined mode of operation, switching between a first mode of operation for exporting and importing power to and from the AC bus and a second mode of operation for providing AC power to the load.

Various advantages, aspects, and novel features of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a diagram of an uninterrupted power supply for use with the system for power conversion of FIG. 1, in accordance with at least some embodiments of the present disclosure; and

FIG. 3 is a method for controlling an energy management system, in accordance with at least some embodiments of the present disclosure.

### DETAILED DESCRIPTION

In accordance with the present disclosure, described herein are improved energy management systems comprising uninterruptible power supplies. For example, an uninterruptible power supplies can comprise a battery configured to connect to a cable that connects to an electrical receptacle of a structure for exporting and importing power to and from an AC bus connected to the energy management system. An electrical receptable can be located on the uninterrupted power supply and configured to provide AC power to a load connected to the uninterrupted power supply. A controller can be configured to switch between a first mode of operation for exporting and importing power to and from the AC bus and a second mode of operation for providing AC power to the load. The uninterruptible power supplies described herein are easy and inexpensive to install (e.g., plugged into a receptable) and do not require permits for use.

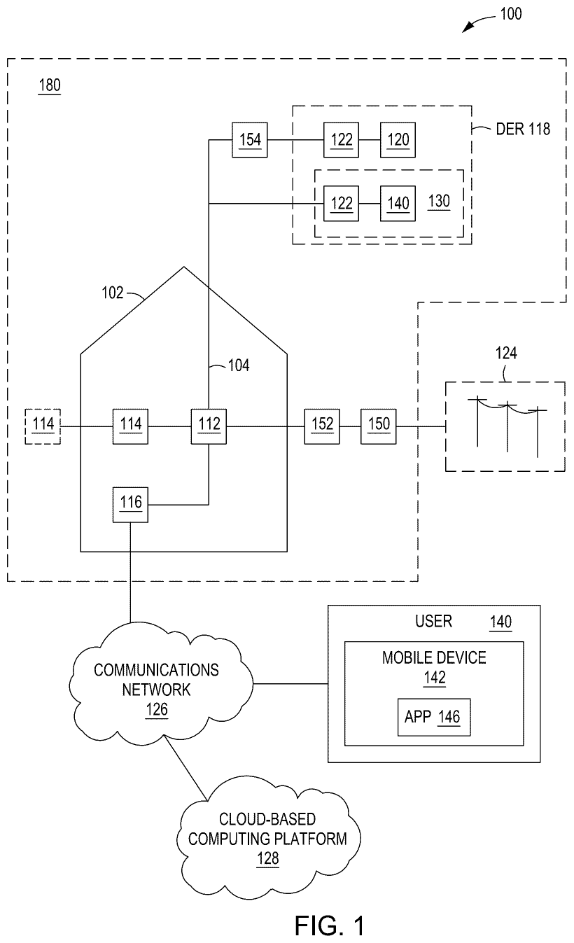

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure, such as a home), such as a residential home, commercial building, or separate mounting structure, having an associated DER 118 (distributed energy resource). The DER 118 is situated external to the structure 102. For example, the DER 118 may be located on the roof of the structure 102 or can be part of a solar farm. Alternatively, the DER 118 can be situated internal to the structure 102. For example, when the DER 118 is a permanent residential battery energy storage system, the DER 118 may be installed in a garage (or other suitable location inside the structure 102). The structure 102 comprises one or more loads and/or energy storage devices 114 (e.g., portable energy systems (PES), appliances, electric hot water heaters, thermostats/detectors, boilers, electric vehicle supply equipment (EVSE), EVs, water pumps, and the like), which can be located within or outside the structure 102, and a DER controller 116, each coupled to a load center 112. Although the energy storage devices 114, the DER controller 116, and the load center 112 are depicted as being located within the structure 102, one or more of these may be located external to the structure 102.

The load center 112 is coupled to the DER 118 by an AC bus 104 and is further coupled, via a meter 152 (utility meter comprising a utility meter socket) and optionally a MID 150 (microgrid interconnect device), to a grid 124 (e.g., a commercial/utility power grid). The structure 102, the energy storage devices 114, DER controller 116, DER 118, load center 112, generation meter 154, the meter 152, and the MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122 (e.g., microinverter, power converter, power conversion units (PCUs), etc.). For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a DC battery 141 may be referred to as an AC battery 130.

The power conditioners 122 invert the generated DC power from the plurality of RESs 120 and/or the DC battery 141 to AC power that is grid-compliant and couple the generated AC power to the grid 124 via the load center 112. The generated AC power may be additionally or alternatively coupled via the load center 112 to the one or more loads (e.g., EV, EVSE) and/or the energy storage devices 114. In addition, the power conditioners 122 that are coupled to the DC batteries convert AC power from the AC bus 104 to DC power for charging the DC batteries. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein (e.g., the methods described herein).

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the DC battery itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage. The meter 152 measures power flows independently of MID state, i.e., when MID is closed and DER's are connected to the grid and when MID is open and DER's are isolated from the grid.

The MID 150, which may also be referred to as an island interconnect device (IID), connects/disconnects the microgrid 180 to/from the grid 124. The MID 150 comprises a disconnect component (e.g., a, relay, a contactor, or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications (e.g., a grid connectivity control application (an application 146)) installed thereon for controlling the connectivity with the grid 124 as described herein. The mobile device 142 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be managed differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

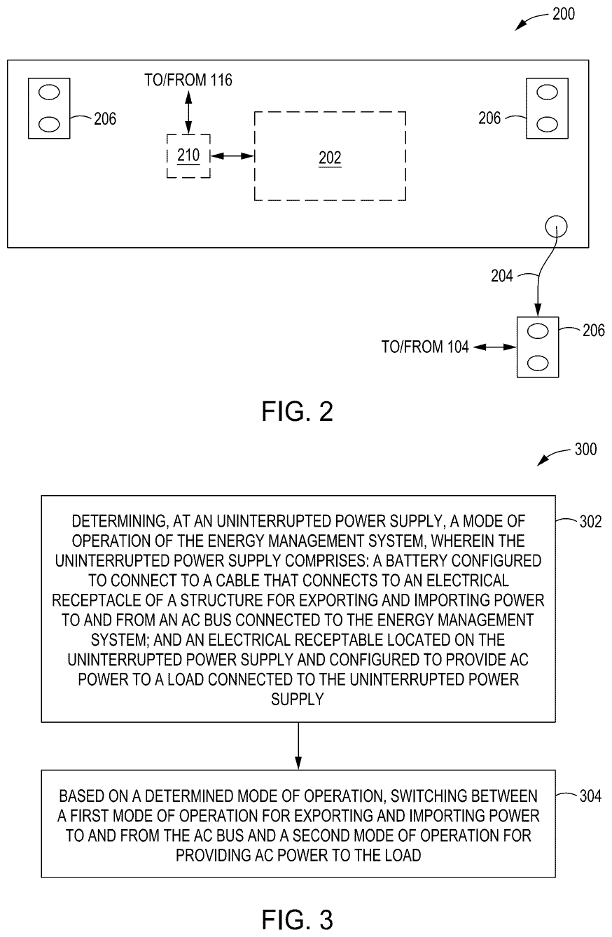

As noted above, the inventors provide herein improved energy management systems comprising uninterruptible power supplies. For example, FIG. 2 is a diagram of an uninterrupted power supply 200 for use with the system 100 for power conversion of FIG. 1, in accordance with at least some embodiments of the present disclosure.

For example, the uninterrupted power supply 200 (e.g., the energy storage devices 114, PES) comprises a battery 202 (e.g., the AC battery 130) configured to connect to a cable 204. The battery 202 can be a Lithium-Ion battery (e.g., one or more types of Lithium-Ion batteries, such as lithium iron phosphate (LFP)).

The cable 204 is configured to connect to an electrical receptable 206 of a structure (e.g., the structure 102) for exporting and importing power to and from an AC bus (e.g., the AC bus 104) connected to the system 100. In at least some embodiments, the electrical receptable 206 can be located on a wall of the structure.

One or more electrical receptables 208 can be located on the uninterrupted power supply 200 and can be configured to provide AC power to a load (e.g., the one or more loads) connected to the uninterrupted power supply 200. For illustrative purposes, the uninterrupted power supply 200 is shown comprising two electrical receptables (e.g., more than one electrical receptable). In operation, when the power goes out, the uninterrupted power supply 200 is configured to stop generating AC for the electrical receptable 206 (e.g., the electrical receptable 206 that the electrical receptable 206 is plugged into), but the electrical receptable 206 would generate AC for the one or more electrical receptables 208. In essence, the electrical receptable 206 becomes a bi-directional UPS. Accordingly, by using the electrical receptable 206, a consumer would see electricity bill cost savings, and since the electrical receptable 206 is provided with long life lithium batteries, the electrical receptable 206 would have a longer operational life when compared to conventional lead acid based consumer battery UPS systems.

A controller 210 (e.g., configured like the DER controller 116) can be in operative communication (e.g., via one or more of PLC, other types of wired communications, or wireless communication) with the DER controller 116 and is configured to switch between a first mode of operation for exporting and importing power to and from the AC bus and a second mode of operation for providing AC power to the load. In at least some embodiments, the controller 210 is configured to detect when the system 100 is an on-grid and off-grid, as described above. In at least some embodiments, the first mode of operation is an on-grid mode and the second mode of operation is an off-grid mode. In at least some embodiments, in the first mode of operation, the uninterrupted power supply 200 is configured to provide power to a second load connected to the energy management system and receive power from a grid, respectively.

FIG. 3 is a flowchart of a method 300 for controlling an energy management system (e.g., the system 100), in accordance with at least some embodiments of the present disclosure. For example, at 302 the method 300 comprises determining, at an uninterrupted power supply, a mode of operation of the energy management system. For example, as noted above, the controller can determine when the system 100 is in a first mode of operation or a second mode of operation.

Next, at 3024, the method 300 comprises, based on a determined mode of operation, switching between a first mode of operation for exporting and importing power to and from the AC bus and a second mode of operation for providing AC power to the load. For example, the controller can switch (e.g., in conjunction with the MID 150) between the first mode of operation for exporting and importing power to and from the AC bus and a second mode of operation for providing AC power to the load.

The uninterrupted power supply 200 and methods of use thereof provides a relatively lower entry cost for storage for a homeowner and is configured to be grid tied so that the uninterrupted power supply 200 can be usable for peak shaving, dynamic tariff, etc. And, since the uninterrupted power supply 200 is grid tied and wall plugged, there is no wiring needed, and the uninterrupted power supply 200 can be sold as a consumer product.

While the foregoing is directed to embodiments of the present disclosure, other and further embodiments of the disclosure may be devised without departing from the basic scope thereof, and the scope thereof is determined by the claims that follow.

1. An uninterrupted power supply configured for use with an energy management system, comprising:
a battery configured to connect to a cable that connects to an electrical receptacle of a structure for exporting and importing power to and from an AC bus connected to the energy management system;
an electrical receptable located on the uninterrupted power supply and configured to provide AC power to a load connected to the uninterrupted power supply; and
a controller configured to switch between a first mode of operation for exporting and importing power to and from the AC bus and a second mode of operation for providing AC power to the load.

2. The uninterrupted power supply of claim 1, wherein the first mode of operation is an on-grid mode and the second mode of operation is an off-grid mode.

3. The uninterrupted power supply of claim 1, wherein the battery is a Lithium-Ion battery.

4. The uninterrupted power supply of claim 1, wherein in the first mode of operation the uninterrupted power supply is configured to provide power to a second load connected to the energy management system and receive power from a grid, respectively.

5. The uninterrupted power supply of claim 1, wherein the electrical receptacle of the structure is located on a wall of the structure.

6. The uninterrupted power supply of claim 1, wherein the uninterrupted power supply comprises more than one electrical receptable.

7. The uninterrupted power supply of claim 1, wherein the controller is further configured to detect when the energy management system is an on-grid and off-grid.

8. An energy management system, comprising:
a distributed energy resource controlled by a distributed energy resource controller;
a load center; and
an uninterrupted power supply comprising:
a battery configured to connect to a cable that connects to an electrical receptacle of a structure for exporting and importing power to and from an AC bus connected to the energy management system;
an electrical receptable located on the uninterrupted power supply and configured to provide AC power to a load connected to the uninterrupted power supply; and
a controller configured to switch between a first mode of operation for exporting and importing power to and from the AC bus and a second mode of operation for providing AC power to the load.

9. The energy management system of claim 8, wherein the first mode of operation is an on-grid mode and the second mode of operation is an off-grid mode.

10. The energy management system of claim 8, wherein the battery is a Lithium-Ion battery.

11. The energy management system of claim 8, wherein in the first mode of operation the uninterrupted power supply is configured to provide power to a second load connected to the energy management system and receive power from a grid, respectively.

12. The energy management system of claim 8, wherein the electrical receptacle of the structure is located on a wall of the structure.

13. The energy management system of claim 8, wherein the uninterrupted power supply comprises more than one electrical receptable.

14. The energy management system of claim 8, wherein the controller is further configured to detect when the energy management system is an on-grid and off-grid.

15. A method for controlling an energy management system, the method comprising:
determining, at an uninterrupted power supply, a mode of operation of the energy management system, wherein the uninterrupted power supply comprises:
a battery configured to connect to a cable that connects to an electrical receptacle of a structure for exporting and importing power to and from an AC bus connected to the energy management system; and
an electrical receptable located on the uninterrupted power supply and configured to provide AC power to a load connected to the uninterrupted power supply; and
based on a determined mode of operation, switching between a first mode of operation for exporting and importing power to and from the AC bus and a second mode of operation for providing AC power to the load.

16. The method of claim 15, wherein the first mode of operation is an on-grid mode and the second mode of operation is an off-grid mode.

17. The method of claim 15, wherein the battery is a Lithium-Ion battery.

18. The method of claim 15, wherein in the first mode of operation the uninterrupted power supply is configured to provide power to a second load connected to the energy management system and receive power from a grid, respectively.

19. The method of claim 15, wherein the electrical receptacle of the structure is located on a wall of the structure.

20. The method of claim 15, wherein the uninterrupted power supply comprises more than one electrical receptable.
